(19) United States
(12) Patent Application Publication
(10) Pub. No.: US 2005/0185583 A1
(43) Pub. Date: Aug. 25, 2005

(54) QoS management for multiple service instances

(76) Inventor: Patrick A. Hosein, San Diego, CA (US)

Correspondence Address: COATS & BENNETT, PLLC, P O BOX 5, RALEIGH, NC, 27602, US

(21) Appl. No.: 10/994,582

(22) Filed: Nov. 22, 2004

Related U.S. Application Data
(60) Provisional application No. 60/545,869, filed on Feb. 19, 2004.

(51) Int. Cl. H04L 1/00

(52) U.S. Cl. 370/232

(57) ABSTRACT

In a mobile communication network, a desired rate needed to maintain a desired quality of service for each service instance is computed and the individual rates for all service instances are summed to get an aggregate rate needed to maintain the desired quality of service for all service instances. A rate determination is made based on the aggregate rate.

### RELATED APPLICATIONS

This application claims priority to Provisional U.S. Patent Application 60/545,869 filed Feb. 19, 2004 which is incorporated herein by reference.

### BACKGROUND OF THE INVENTION

The present invention relates generally to high rate packet data services for mobile communications, and more particularly, to a method of controlling the data transmission rate on forward or reverse link channels to maintain a desired quality of service.

Third Generation wireless networks currently being deployed provide high-speed data services on both forward and reverse channels. However, these services are best effort services without any quality of service (QoS) guarantees. QoS is a guarantee by the network to satisfy a set of predetermined service performance constraints such as throughput, rate, end-to-end delays, jitter, and probability of packet loss. QoS guarantees are conventionally attained through resource reservation. A connection with reserved capacity is established with the end user and the reserved resources are used to transmit data packets to the user to guarantee the quality of service. In wireless networks, the resources needed to meet QoS constraints are constantly varying due to mobile station mobility.

Recent revisions to the 1XEV-DV standard include enhancements to enforce QoS constraints and enable operators to provide QoS guarantees to mobile users. Similar features are being included in 1XEV-DO and WCDMA. These enhancements allow operators to guarantee service performance on application requirements such as goodput, jitter, delay and error rate. Users may run multiple QoS enabled applications simultaneously. Each is supported by a corresponding service instance distinguished by its service identification number.

In the 1 XEV-DV Revision D standard, each mobile reports information (buffer occupancy and power headroom) for each service instance (SI) to the base station. These reports can be triggered by certain events (such as queue length thresholds) or may be sent periodically. The base station uses this information to decide on the appropriate rate to assign to the mobile.

Typically, reporting of power headroom and buffer levels is done separately for each Si. Consequently, the signaling required to meet QoS guarantees increases as the number of service instances increases. Because mobile stations will frequently have multiple simultaneous SIs, it is desirable to reduce the signaling overhead required to guarantee QoS so that system resources are not strained by the additional signaling loads.

### SUMMARY OF THE INVENTION

The present invention provides a method and apparatus for controlling a data transmission rate to satisfy a desired quality of service (QoS). A rate needed to meet a desired quality of service is determined separately for each one of a plurality of applications or service instances. The desired rate for each application or service instance is then summed to determine an aggregate rate for all applications or service instances. The rate determination is made based on the aggregate rate. The present invention may be used to control the data transmission rate on the forward and reverse packet data channels.

The present invention may be implemented, for example, in a mobile station to control the data transmission rate of the mobile station on a reverse packet data channel. In this embodiment of the invention, the mobile station computes a service rate needed to maintain a desired quality of service for each service instance and sums the desired rates to compute an aggregate rate for all applications or service instances. The mobile station then determines a desired transmission rate for the R-PDCH based on the aggregate rate needed to maintain the desired quality of service for all applications or service instances and sends a rate request to the base station. The desired transmission rate may be determined by mapping the aggregate rate to the nearest allowed rate. If the aggregate rate exceeds the maximum allowed rate, the mobile station requests the maximum rate. If the mobile station does not have enough power to transmit at a rate needed to maintain the desired quality of service, the mobile station adjusts the rate request downward to a level that can be achieved by the mobile station considering the available power.

In another aspect of the present invention, the mobile station may dither the rate over a predefined control period to achieve an effective rate approximately equal to the aggregate rate. The mobile station can alternate its transmission rate between two or more selected rates during a single rate control period. In one embodiment of the invention, the mobile station transmits at a first rate for a predetermined number of frames in the rate control period, and at a second rate for the remaining frames. This concept may be extended to three or more rates.

### BRIEF DESCRIPTION OF THE DRAWINGS

FIG. 1 is a block diagram illustrating the logical elements of an exemplary mobile communication network according to the present invention.

FIG. 2 is a block diagram of an exemplary base station for a mobile communication network according to the present invention.

FIG. 3 is a block diagram of an exemplary mobile station according to the present invention.

FIG. 4 is a flow chart of an exemplary procedure executed by the mobile station.

### DETAILED DESCRIPTION OF THE INVENTION

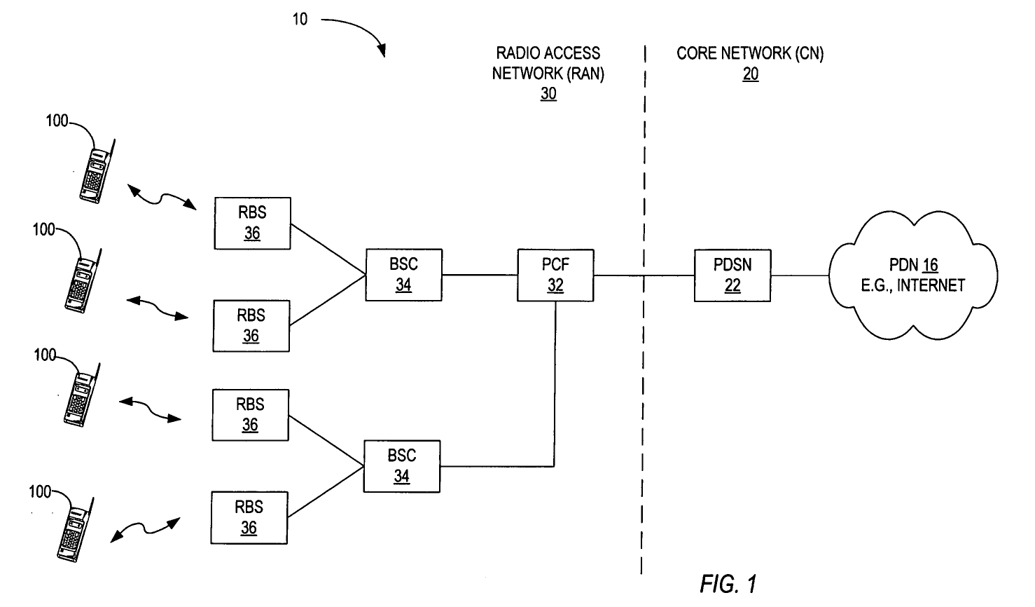

FIG. 1 illustrates logical entities of an exemplary wireless communication network 10 that provides packet data services to mobile stations 12. The wireless communication network 10 is a packet-switched network, such as a CDMA network, WCDMA network, EDGE network, or UMTS network. FIG. 1 illustrates a wireless communication network 10 configured according to the cdma2000 (IS2000) standards. Wireless communication network 10 comprises a packet-switched core network 20 and a radio access network (RAN) 30. The core network 20 includes a Packet Data Serving Node (PDSN) 22 that connects to an external packet data network (PDN) 16, such as the Internet, and supports PPP connections to and from the mobile station 12. Core network 20 adds and removes IP streams to and from the RAN 30 and routes packets between the external packet data network 16 and the RAN 30. RAN 30 connects to the core network 20 and gives mobile stations 12 access to the core network 20.

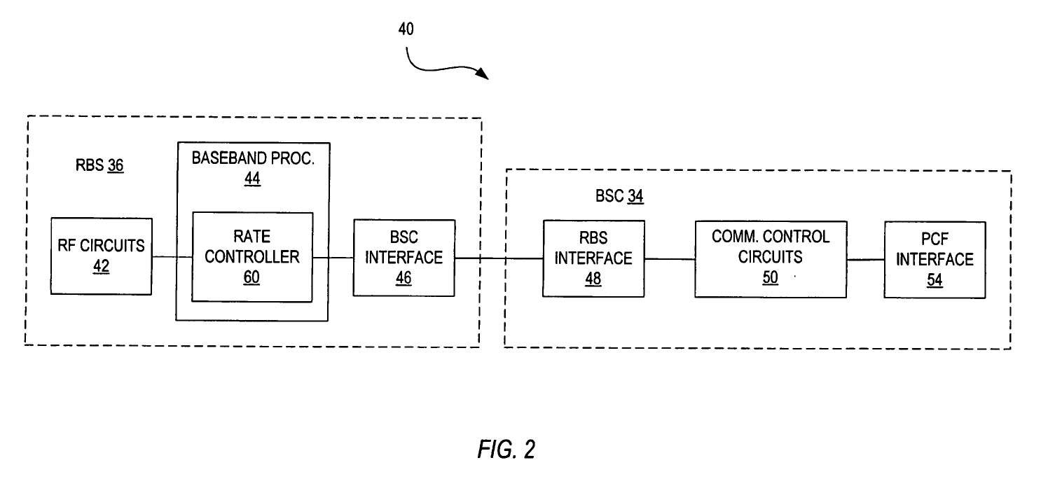

RAN 30 includes a Packet Control Function (PCF) 32, one or more Base Station Controllers (BSCs) 34 and one or more radio base stations (RBSs) 36. The primary function of the PCF 32 is to establish, maintain, and terminate connections to the PDSN 22. The BSCs 34 manage the radio resources within their respective coverage areas. The RBSs 36 include the radio equipment for communicating over the air interface with mobile stations 12. A BSC 34 can manage more than one RBSs 36. In cdma2000 networks, a BSC 34 and an RBS 36 comprise a base station 40 (FIG. 2), which is described in more detail below. The BSC 34 is the control part of the base station 40. The RBS 36 is the part of the base station 40 that includes the radio equipment and is normally associated with a cell site. In cdma2000 networks, a single BSC 34 may comprise the control part of multiple base stations 40. In other network architectures based on other standards, the network components comprising the base station 40 may be different but the overall functionality will be the same or similar.

FIG. 2 illustrates exemplary details of a base station 40 in a cdma2000 network. The base station components in the exemplary embodiment are distributed between a RBS 36 and a BSC 34. The RBS 36 includes RF circuits 42, baseband processing and control circuits 44, and interface circuits 46 for communicating with the BSC 34 the baseband processing and control circuits include a rate controller 60 as further described below. The rate controller 60 schedules the data transmission rates of mobile station s 100 on the Reverse Packet Data Channel (R-RPDCH) as described more fully below. The baseband processing and control circuits 44 may comprise one or more processors. The BSC 34 includes interface circuits 48 for communicating with the RBS 36, communication control circuits 50, and interface circuits 54 for communicating with the PCF 32. The communication control circuits 50 manage the radio and communication resources used by the base station 40. The communication control circuits 50 may comprise one or more processors programmed to carry out the functions of the communication control circuits 50.

Revisions C and D of the cdma2000 standard, generally known as 1xEV-DV, introduced forward and reverse packet data channels designed for high speed packet data communications well beyond what is currently available in cdma2000 1× networks. The 1xEV-DV standard also includes enhancements making it possible for network operators to provide quality of service (QoS) guarantees to subscribers. The present invention is described below in the context of controlling the data transmission rate of a mobile station 100 on a reverse packet data channel to maintain a desired quality of service. Those skilled in the art will recognize that the present invention is equally applicable to controlling a data transmission rate on a forward packet data channel.

The R-PDCH is divided into 10 ms frames. A mobile station transmits a data packet in each frame ranging in size from 192 bits to 18,432 bits. The 10 ms frame duration in combination with the variable packet size allows the mobile station 100 to obtain data rates ranging from 6.4 kbps to 1,8432 kbps. To address QoS for the reverse link, the cdma2000 standard defines an autonomous transmission mode that allows the mobile station 100 to start data transmission at any time up to a specified maximum autonomous rate thereby reducing delays. Once the mobile station 100 begins transmitting, the mobile station 100 is allowed to vary its data transmission rate depending on factors such as the channel conditions of the mobile stations 100, power availability, QoS constraints, buffer levels at the mobile station, and load levels at the base station 40.

In cdma2000 networks, the mobile station 100 reports its buffer levels and power availability to the base station 40 over a Reverse Request Channel (R-REQCH) for each service instance (SI). The rate controller 60 at the base station 40 determines the data transmission rate for the mobile station 100 that meets QoS guarantees based on the reports from the mobile station 100. If a mobile station 100 has many SIs, the signaling overhead to meet QoS guarantees can consume a significant amount of the reverse link bandwidth. The present invention reduces the signaling required to maintain the desired QoS on the R-PDCH.

According to the present invention, the mobile station 100 determines an aggregate rate needed to maintain a desired QoS for all SIs. It is assumed that a single reverse link channel is used for all SIs. The aggregate rate is computed by determining a desired rate needed for each SI to maintain specified QoS constraints and summing the individual rates for each SI to obtain the aggregate rate. The mobile station 100 requests a desired rate based on the aggregate rate. The base station 40 receives the rate requests and schedules the rate for the mobile station 100 based on the requested rates. Because the mobile station 100 sends a single rate request for all service instances, signaling overhead is substantially reduced.

The following model provides a basis for computing the rate needed for each application to maintain its QoS guarantee. Assume that the IP packets of each SI are split into multiple RLP (Radio Link Protocol) frames and placed at the tail of its RLP buffer. The RLP frames in this buffer are served in a First In First Out (FIFO) fashion. If the transmission of a RLP frame fails then it is retransmitted at the physical layer. This is repeated if necessary for some specified number of times. Such RLP frames are placed in a retransmit buffer and are given strictly higher service priority over new frame transmissions.

The physical layer frame consists of one or more RLP frames. The number of data bits per physical layer frame depends on the reverse link rate of the mobile. If the first transmission of a physical layer frame is unsuccessful then it is retransmitted up to a maximum of two retransmissions. These re-transmissions are combined with earlier transmissions (soft combining) to increase probability of success. The transmission power of each transmission is varied so that the residual FER (after all transmissions) is at most 1%. Note that the 1% failures are retransmitted at the RLP layer but with a fresh round of physical layer transmissions.

On a periodic basis (with period r which is assumed to be a multiple of a frame duration), the mobile station 100 counts the number of information bits, bᵢ(n), that depart the original transmission queue during period n (the prior period) for SI i. It also determines the size of this queue, qᵢ(n) (in units of information bits). A filtered information bit departure rate of the original transmission buffer for a given SI is given by:

$${μ}_{i} ( n ) = {α}_{μ} \frac{{b}_{i} ( n )}{τ} + ( 1 - {α}_{μ} ) {μ}_{i} ( n - 1 ) \qquad Eq . ( 1 )$$

where α_{μ}, is the corresponding filter constant and μᵢ(0)=0.

The number of information bits that arrive during the same period is given by bᵢ(n)+qᵢ(n)−qᵢ(n−1). Therefore a filtered information bit arrival rate is given by:

$${λ}_{i} ( n ) = {α}_{λ} \frac{{b}_{i} ( n ) + {q}_{i} ( n ) - {q}_{i} ( n - 1 )}{τ} + ( 1 - {α}_{λ} ) {λ}_{i} ( n - 1 ) \qquad Eq . ( 2 )$$

where α_{λ} is the corresponding filter time constant and λᵢ(0)=0.

For purposes of computing a desired rate, it is assumed that each RLP frame departing the original transmission queue eventually arrives successfully at the base station 40. In other words we assume an unlimited number of RLP retransmissions. Under this assumption, this information bit departure rate, denoted μᵢ, equals the goodput gᵢ of the channel since it is the rate of successfully received frames. If we denote the overhead incurred (due to physical and RLP layer re-transmissions) in transmitting an RLP frame over the air interface by ρ we have the following relation:
μᵢ=(1−ρ)rᵢ Eq. (3)
Therefore at the end of period n we can estimate ρ(n) according to:

$$ρ ( n ) = {α}_{ρ} ( 1 - \frac{{\sum }_{i} {μ}_{i} ( n )}{R ( n )} ) + ( 1 - {α}_{ρ} ) ρ ( n - 1 ) \qquad Eq . ( 4 )$$

where α_{ρ} is the filter constant, ρ(0)=0 and R(n)=Σᵢrᵢ(n) is the reverse link rate. This overhead estimate ρ(n) will be used by all SIs to compute a desired service rate for each service SI. The goodput gᵢ(n) of SI i during period n is estimated by:
gᵢ(n)=(1−ρ(n))rᵢ(n) Eq. (5)

At the beginning of control period n, we assume that SI i requires a rate \tilde{r}ᵢ(n) to maintain QoS constraints and is assigned (after some delay) a rate rᵢ(n) by the base station 40 for the subsequent control period. The difference between rᵢ(n) and \tilde{r}ᵢ(n) is due to the finite number of rates supported in the reverse direction. At each decision point (i.e., every τ seconds) the objective is to determine the service rate \tilde{r}(n+1), that should be applied in the subsequent interval so that at the end of the interval n+1 the expected value of the concerned QoS attribute equals the desired value. Note that this is computed for each SI and hence the request that is sent to the base station 40 is obtained by summing over all SIs. The above described model may be used by the mobile station 100 to compute the desired rate for a given SI based on a variety of QoS guarantees including a goodput guarantee, a jitter guarantee, a delay guarantee, a frame error rate (FER) guarantee, or other guarantee. The computation of the desired rate for an SI is discussed below.

Goodput Guarantee

Many applications require some minimum goodput for acceptable performance. Simply providing a constant rate corresponding to the desired goodput is not sufficient because there will be some transmission errors. If the channel frame error rate increases then the rate must also be increased in order to maintain the specified goodput.

The mobile station 100 computes a service rate \tilde{r} needed to maintain the goodput g at a desired minimum value. If more resources than are necessary are provided then the resulting system capacity (number of supported users) will be reduced. Therefore, it is assumed that the SI is served at the minimum rate needed to maintain the desired goodput g.

Recall that an estimate of the goodput is given by the information bit departure rate μᵢ(n), which is known. The overhead estimate ρ(n) can be computed according to Equation 5. To calculate a desired rate \tilde{r}(n+1) for the next rate control interval, the overhead ρ(n) for the current period is used to approximate the overhead ρ(n+1) in the subsequent period. Therefore, the goodput for the subsequent rate control period to maintain a desired QoS is approximated by:
g=(1−ρ(n))\tilde{r}(n+1) tm Eq. (6)

Solving Equation 6 to get the desired rate \tilde{r}(n+1) yields:

$$\tilde{r} ( n + 1 ) = \frac{g}{1 - ρ ( n )} \qquad Eq , ( 7 )$$

Note that the goodput g is given and the overhead ρ(n) is known. Therefore, Equation 7 can be used to compute the desired rate \tilde{r}(n+1) for a given SI. As the FER increases, ρ(n) (given in Equation 4) increases since more retransmissions (at both physical and RLP layers) are necessary. This results in an increase in the requested rate to compensate for the errors to maintain the same goodput.

Jitter Guarantee

In the case of jitter guarantees, the total delay (queuing and transmission) should be maintained at some specified target value d_{T}. Therefore the objective becomes the determination of the rate \tilde{r}(n+1) for the next interval such that the expected value of the delay at the end of the interval \tilde{r}(n+1) equals d_{T}.

The expected queue size at the end of the interval q(n+1) that corresponds to this delay d_{T} is given by d_{T}μ(n+1). The expected queue dynamics during the interval is given by:
q(n)+λ(n)τ−μ(n+1)τ=d_{T}μ(n+1) Eq. (8)
The bit departure rate μ(n+1) for the subsequent rate control interval is given by:
μ(n+1)=(1−ρ(n))\tilde{r}(n+1) Eq. (9)
In Equation 9 the overhead for the current period is used to approximate the overhead for the subsequent period as previously described. Substituting Equation 9 into Equation 8 and solving for \tilde{r}(n+1) gives:

$$\tilde{r} ( n + 1 ) = \frac{q ( n ) + λ ( n ) τ}{( 1 - ρ ( n ) ) ( τ + {d}_{T} )} \qquad Eq . ( 9 )$$

Note that the desired rate increases with increasing queue length, arrival rate and overhead as expected.

Delay Guarantee

In the case of a maximum delay guarantee, the delay should be kept below some specified value d_{MAX}. As long as the queuing delay is below this value then it is best to maintain the rate close to the arrival rate so that the queuing delays do not increase. As the delay approaches d_{MAX} the rate should be increased accordingly.

This problem is similar to the case of jitter guarantee. In this case we can assume a target value of d_{T}=0. However, unlike the jitter case, it is not vital to get the delay to this value within a single interval. In fact, the targeted time in the future at which we would like the delay to go to zero should depend on how close the present delay is to the maximum value. If it is very close to the maximum then the delay should be brought down quickly (say within one interval). If the delay is already close to zero then it should be brought to zero more slowly.

A target time T to bring the present delay to zero can be computed as a ratio of the maximum delay d_{MAX} to the present estimate of the queuing delay d(n), i.e. d_{MAX}Id (n). The present estimate of the queuing delay can be obtained by dividing the buffer occupancy q(n) by the bit departure rate μ(n), i.e., d(n)=q(n)Iμ(n). Therefore, the target time T is given by:
T=d_{MAX}μ(n)Iq(n). Eq. (10)
Substituting Equation 10 into Equation 9 and using the fact that d_{T}=0 we obtain:

$$\tilde{r} ( n + 1 ) = \frac{q ( {n}^{2} ) + λ ( n ) μ ( n ) {d}_{max}}{( 1 - ρ ( n ) ) {d}_{max} μ ( n )} \qquad Eq . ( 11 )$$

Note that the requested rate \tilde{r}(n+1) increases as the buffer occupancy and bit arrival rate increases and decreases as the bit departure rate increases as would be expected.

Typically, each mobile station 100 has a finite sized buffer allocated to each SI. This buffer may not be large enough to support an application with a large delay threshold running at very high reverse link rates. Since the rate granted to a mobile station 100 is not exactly what was desired then it is possible that during the subsequent period the buffer may either overflow or underflow. However, it is easy to determine this in advance. Once the mobile station 100 determines the rate that will be granted by the base station 40 then it can predict the queue length at the end of the subsequent control period. If this is bigger than the buffer size then the requested rate should be adjusted upward while if the predicted queue length is negative then the requested rate should be adjusted downward. The objective being to reduce the occurrence of buffer overflows and underflows.

FER Guarantee

Some applications may require that packet loss be kept below a minimal IP packet loss rate. This can be provided by an appropriate number of RLP retransmissions if packet transmission delay guarantees are not needed. However, if packet latency is also a concern then FER reduction should be done at the physical layer since less delay is incurred. Since soft recombining is performed at the physical layer, the probability of success of one additional physical layer retransmission is much higher than the probability of success of the first physical layer transmission in a subsequent RLP round. Furthermore, the additional delay incurred in the physical layer case is much smaller than that in the RLP retransmission case.

The physical layer FER can be reduced by increasing the maximum number of H-ARQ retransmissions. However, this also results in increased delay. To maintain the same delay, the power assigned for each frame transmission can be increased (power boosting) so that the SNR of the received signal is increased thus reducing the probability of error. This approach is recommended in the 1 XEV-DV standard.

As described above, the mobile station 100 computes a desired rate for each SI based on a QoS guarantee for the SI and sums them to obtain a desired aggregate rate. Since the reverse link only supports a finite set of rates (namely 19.2, 40.8, 79.2, 156.0, 309.6, 463.2, 616.8, 924.0, 1231.2, 1538.4 and 1845.6 kbps), the mobile's desired aggregate rate has to be mapped to one of the available rates. One solution is to map to the aggregate rate to the nearest supportable rate. Alternatively, the mobile station 100 could map the aggregate rate to the next higher supported rate, or to the next lower supported rate.

Since consecutive supported rates differ by a factor of two, the resulting control will tend to be very oscillatory. According to one embodiment of the present invention, an effective rate approximately equal to the desired aggregate rate can be obtained by dithering rates during a predetermined rate control period. Assume that a rate control period consists of K frames. Suppose that the desired aggregate rate for the rate control period is R and denote the smallest supported rate higher than R and the largest supported rate lower than R by Rₕ and Rₗ, respectively. There exists 0≦β≦1 such that R=βRₗ(1−β)Rₕ. If the mobile station 100 transmits at rate Rₗ for a fraction of the K frames and at rate Rₕ for the remaining frames, an effective rate approximately equal to the desired aggregate rate can be obtained.

If f denotes the nearest integer to βK, the mobile station 100 may send a request message to the base station 40 containing Rₗ and f. If the base station 40 grants the request, mobile station 100 transmits the first f frames in the corresponding rate control period at rate Rₗ while all subsequent new frame transmissions are sent at rate Rₕ.

In practice it takes some finite period of time for the mobile station 100 to determine the desired aggregate rate and send a rate request to the base station 40. The base station 40 then has to determine what rate to assign and send a grant message back to the mobile station 100. This signaling takes on the order of 40 ms. To account for the feedback and signaling delays, estimates of μ, λ, q, ρ, etc, be computed every τ seconds as previously explained. However, knowing that the new rate will take effect some time T in the future, the queue length \tilde{q} at time T in the future is predicted according to:
\tilde{q}'max{0,q+(2−μ)T}, Eq, (12)
where λ and μ are the estimates made when the rate request is being computed (i.e., we assume they do not change over the period of time T). The predicted queue length \tilde{q} may then be used instead of q and perform the same computations as before.

There may be some circumstances where QoS guarantees cannot be met during a given rate control period. A mobile station 100 is typically limited by one of three factors, the maximum and minimum supportable rates, its maximum transmission power (200 mW), and reverse link interference. The QoS requirement cannot be met where the aggregate rate needed to maintain the QoS guarantee exceeds the maximum transmit rate of the mobile station 100. In this situation, the mobile station 100 should request the maximum rate.

The transmit power limit of the mobile station 100 may also prevent QoS guarantees from being met. A mobile station 100 becomes power limited when it is in relatively poor radio conditions but its applications have high resource demands. It is not able to transmit at its desired rates because of lack of transmission power. Therefore, when making a rate request decision, the mobile station 100 should first determine if its available power can support the requested rate. If not then it should request the highest rate that can be supported by its available power. This decision is thus local to the mobile station 100 and power information need not be reported to the base station 40.

If the reverse link interference is high, the base station 40 may not be able to grant the rate requested by the mobile station 100 which means that the base station 40 may not be able to guarantee the QoS it initially agreed upon. In such a case the reverse link is overloaded.

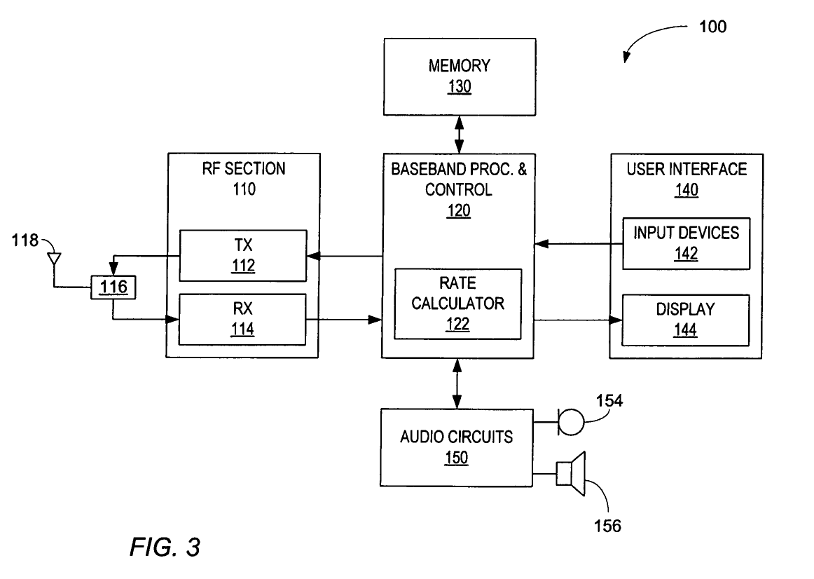

FIG. 3 illustrates exemplary details of a mobile station 100 according to the present invention. The mobile station 100 includes an RF section 110, baseband processing and control circuits 120, memory 130, user interface 140, and audio circuits 150. RF section 110 provides a radio interface for communicating with a base station. The RF section 110 comprises a transmitter 112 and receiver 114 coupled to a shared antenna 118 through an RF switch 116. Transmitter 112 modulates transmitted signals onto an RF carrier and amplifies the transmit signal for transmission to a base station 40. Receiver 114 filters, amplifies, and downconverts received signals to baseband for processing by the baseband processing and control circuits 120.

The baseband processing and control circuits 120 perform baseband processing for signals transmitted from and received by the mobile station 100, and controls the overall operation of the mobile station 100. The baseband processing and control circuits 120 may comprise one or more processors, hardware, firmware, or a combination thereof. The baseband processing and control circuits 120 include a rate calculator 122 that determines the desired rates for each SI, computes the aggregate rate for all SIs, and determines the requested rate as described above.

Memory 130 stores programs and data used by the baseband processing and control circuits 120. Memory 130 may also store user applications. Memory 130 may comprise one or more memory devices and may include both random access memory (RAM) and read-only memory (ROM). Computer programs and data required for operation of the device are stored in non-volatile memory, such as EPROM, EEPROM, and/or flash memory. The memory devices may be implemented as discrete devices, stacked devices, or integrated with processors in the baseband processing and control circuits 120.

User interface 140 comprises one or more input devices 142 and a display 144. The input devices may comprise a keypad, joy stick control, touch pad, dial or any other known type of input device. Display 144 may comprise a conventional LCD or may comprise a touch screen display that also serves as an input device 142.

Audio circuits 150 include audio processing circuits 152, microphone 154, and speaker 156. Audio processing circuits 152 include D-to-A converters to convert digitized audio to analog signals suitable for output to speaker 156, and analog-to-digital converters for converting analog input signals from microphone 154 to digitized audio suitable for input to the baseband processing and control circuits 120. Microphone 154 converts the user's speech and other audible signals into electrical audio signals, and speaker 156 converts analog audio signals into audible signals that can be heard by the user.

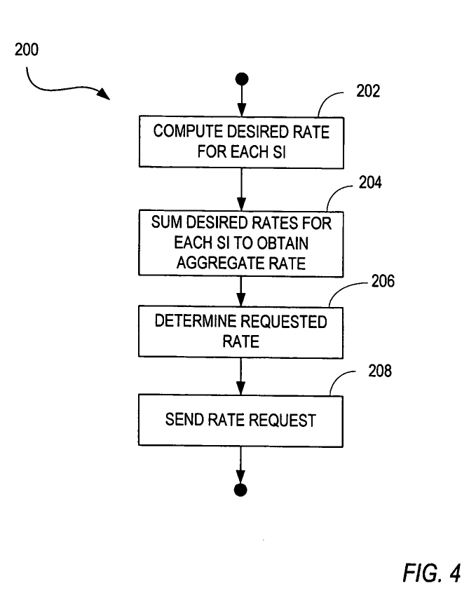

FIG. 4 is a flow chart illustrating a rate control procedure 200 executed by the mobile station 100. The rate control procedure 200 is executed for each rate control period, which may be one or more frames. The mobile station 100 computes a desired rate R for each application or service instance (SI) (block 202), and sums the desired rates for all SIs to get an aggregate rate (block 204). After determining the aggregate rate, the mobile station 100 determines a requested rate based on the aggregate rate (block 206). As previously described, the mobile station 100 may choose the nearest supported rate, the next higher supported rate, or the next lower supported rate. Alternatively, the mobile station could determine a rate pair {Rₗ,Rₕ} that yields an effective rate over a rate control period approximately equal to the aggregate rate. The mobile station 100 then sends a rate request to the base station (block 208). If a fixed rate is requested, the rate request includes the desired fixed rate. In embodiments where the mobile station 100 alternates between two rates to obtain a desired effective rate for the rate control period, the mobile station 100 sends the base station 40 a rate request indicating the rates it will use during the rate control period and the frames in which those rates will be used. For example, the rate request may specify one rate and the number of frames that the specified rate will be used. The mobile station 100 would then transmit at the specified rate for the specified number of frames and switch to the next higher or next lower rate for the remaining frames.

In any case, those skilled in the art should appreciate that the present invention is not limited by the foregoing discussion, nor by the accompanying figures. Rather, the present invention is limited only by the following claims and their reasonable legal equivalents.

1. A method of controlling a data transmission rate for transmission of data between a mobile station and a base station in a wireless communication network, the method comprising:
computing, for each one of a plurality of service instances, an estimated data rate needed to maintain a desired quality of service for that service instance;
summing the data rates for all service instances to determined an aggregate rate needed to maintain the desired quality of service for all service instances; and
determining a transmission rate for transmission of data between said mobile station and said base station based on said aggregate rate.

2. The rate control method of claim 1 wherein the transmission data rate is selected from a schedule of available rates based on the aggregate rate needed to maintain the desired quality of service for all service instances

3. The rate control method of claim 2 wherein the transmission rate is the nearest one of the available rates that is greater than or equal to the aggregate rate needed to maintain the desired quality of service for all service instances.

4. The rate control method of claim 2 wherein the transmission rate is the nearest one of the available rates that is less than or equal to the aggregate rate needed to maintain the desired quality of service for all service instances.

5. The rate control method of claim 1 wherein the aggregate rate is used to determine an effective rate for a predetermined control period.

6. The rate control method of claim 5 wherein the rate control period comprises a plurality of frames, and wherein the transmission rate for each frame is selected to obtain the effective rate for the control period.

7. The rate control method of claim 6 wherein the transmission rate is varied between two or more available rates in different frames in the same rate control period to achieve the effective rate for the rate control period.

8. The rate control method of claim 1 wherein the rate needed to maintain a desired quality of service for each service instance based on a desired jitter.

9. The rate control method of claim 1 wherein the rate needed to maintain a desired quality of service for each service instance based on a desired throughput.

10. The rate control method of claim 1 wherein the rate needed to maintain a desired quality of service for each service instance based on a desired delay.

11. The rate control method of claim 1 wherein the rate needed to maintain a desired quality of service for each service instance based on a desired frame error rate.

12. The rate control method of claim 1 wherein the transmission rate is a desired transmission rate computed by a mobile station, and further comprising sending a data rate request from the mobile station to a base station including the desired transmission rate.

13. A mobile station comprising:
a transceiver for transmitting and receiving signals; and
a controller operatively connected to said transceiver, said controller including a rate calculator to determine an aggregate data transmission rate on a reverse link channel based on a desired quality of service for a plurality of service instances, and to send a data rate request from said mobile station to a base station, said data rate request indicating a desired transmission rate based on said aggregate rate.

14. The mobile station of claim 13 wherein the rate control processor selects a desired transmission data rate from a schedule of available rates based on the aggregate rate needed to maintain the desired quality of service for all service instances

15. The mobile station of claim 14 wherein the rate control processor selects the nearest one of the available rates that is greater than or equal to the aggregate rate needed to maintain the desired quality of service for all service instances.

16. The mobile station of claim 14 wherein the rate control processor selects the nearest one of the available rates that is less than or equal to the aggregate rate needed to maintain the desired quality of service for all service instances.

17. The mobile station of claim 13 wherein the rate control processor determines an effective rate for a predetermined control period based on said aggregate rate.

18. The mobile station of claim 17 wherein the rate control period comprises a plurality of frames, and wherein the transmission rate for each frame is selected to obtain the effective rate for the control period.

19. The mobile station of claim 13 wherein the rate calculator determines the estimated rate needed to maintain a desired quality of service for each service instance based on a desired jitter.

20. The mobile station of claim 13 wherein the rate calculator determines the estimated rate needed to maintain a desired quality of service for each service instance based on a desired throughput.

21. The mobile station of claim 13 wherein the rate calculator determines the estimated rate needed to maintain desired quality of service for each service instance based on a desired delay.

22. The mobile station of claim 13 wherein the rate calculator determines the estimated rate needed to maintain a desired quality of service for each service instance based on a desired frame error rate.
